(19) United States
(12) Patent Application Publication
(10) Pub. No.: US 2009/0119980 A1
(43) Pub. Date: May 14, 2009

(54) ABANDONED MINE DISCHARGE ALGAE CLEAN UP

(76) Inventor: Howard Walker, Johnstown, PA (US)

Correspondence Address: MICHAEL RIES, 318 PARKER PLACE, OSWEGO, IL, 60543, US

(21) Appl. No.: 12/267,564

(22) Filed: Nov. 8, 2008

Related U.S. Application Data
(60) Provisional application No. 60/986,293, filed on Nov. 8, 2007.

(51) Int. Cl. C10L 1/18; C02F 3/32

(52) U.S. Cl. 44/308; 210/602

(57) ABSTRACT

Disclosed herein is a new method of producing biodiesel fuel using algae grown on the polluted water from mine acid water drainage ponds. By directly using the water from the mines the necessity of adding costly nutrient chemicals to the water to produce the algae is eliminated.

This application claims priority to U.S. Provisional Application 60/986,293 filed 8 Nov. 2007, the entire disclosure of which is incorporated by reference.

### TECHNICAL FIELD AND BACKGROUND

The present invention relates to abandon mine discharge or AMD. More Specifically the present invention is solves abandoned mine discharge and produces a renewable energy feed stock.

The present invention solves abandoned mine discharge and produces a renewable energy feed stock. Algae has been used in the past for treating sewer water. No one has looked into mine treatment. The improvement are that in the past 20 years removal of the minerals from the AMD water have not been cost effective. The use of the present invention is to remove heavy metals to clean the water and reduce CO2 levels and oxygenize the water so that aquatic life can live.

The different ways the present invention can achieve the desired result is to introduce algae to the AMD water or algae is present to increase the levels of whatever mineral or nutrient is lacking. Required elements and nutrients are CO2, Carbon, Ca, Cu, Fe, Mg, Mn, MO, K, Zn, proper temperature and light source. Introduce algae to the AMD water or algae is present to increase the levels of whatever mineral or nutrient is lacking.

The objective of our invention is to clean AMD Water while at the same time producing an unlimited low cost renewable feedstock for alternative energy.

Algae production has been around for many years and it has been difficult to make it cost effective. Some companies have used power plants for it's source of CO2. However, these plants do not have the nutrients necessary and must introduce minerals into the process for maximal algae growth.

Our process uses the dissolved CO2 from the coal mine's discharged water which can be 100 times greater than CO2 levels in the atmosphere. Our process also uses the dissolved metals as nutrients from the mine water making it much more cost effective to produce the algae.

In the past people have looked at recapturing the metals for assistance in cleaning the mine water. This has not been cost effective. This is the first time CO2 in the water has been looked at as an element for cost effective manufacturing.

Our process utilizes mine water discharge as it's supply source. This supply source has been considered a pollution problem with no profitable solution.

Our process cleans a 220 million dollar problem in Pennsylvania from past energy projects while producing a renewable feedstock for renewable energies.

The present invention is a new method of producing biodiesel fuel using algae grown on the polluted water from mine acid water drainage ponds. By directly using the water from the mines the necessity of adding costly nutrient chemicals to the water to produce the algae is eliminated. The method must be very accurately carried out to make use of the unique chemistry of mine acid drainage water: The method produces copious quantity of algae and simultaneously cleanses the polluted water. The method for the first time uses polluted mine acid drainage water to produce a plant which both cleanses the water and itself is a most promising source of oil for biodiesel production. The polluted water provides highly favorable conditions for the rapid growth of algae which shows great potential as a worldwide energy source.

### DETAILED DESCRIPTION

Although the process for producing biodiesel fuel from plants oils and fruits has been known and used for many years, the large-scale production of biodiesel for fuel has been limited by the fact that the plant sources, such as corn, are urgently required for both human and animal consumption. Only algae, with its high oil content and its ability to be grown in a wide variety of conditions in great volumes per acre, has been available for large commercial production of biodiesel for fuel, free from the basic needs for human and animal consumption.

In the past, the existence of oil in algae has been known; therefore, all processes for making biodiesel fuel from algae has involved the use of costly nutrients to grow the algae. This algae utilization process for commercial production of biodiesel on a large scale is severely limited by the excessive time, energy consumption and cost, due to the necessity of first having to provide CO2 and costly nutrient to provide suitable growth, and only after this long process could the algae be harvested and processed to produce substantial oil. The fact that dissolved CO2 and nutrients was already available in the polluted water escaping the abandoned mines of Pennsylvania has escaped recognition until now, in this method being described herein.

Accordingly, it is the general objective of the present invention to provide a method of algae production from the water of mine acid drainage sites.

The present invention was developed to meet the challenge of energy and pollution cleanup needs and provide a plentiful source of both energy and food from a plant not yet being used on a commercial scale due to prohibitively high time, energy and cost requirements. Algae was selected for this production of biodiesel fuel due to first, its very high oil content; second, its unusual ability to thrive in most climatic conditions including polluted waters; and third, its ability to produce tremendous volumes of plants per acre.

Until the present invention described method, no practical means was known to grow algae other than the time and energy inefficient process of adding CO2 and costly nutrients to the water and using the algae oil produce biodiesel fuel. The concept of adding gases and nutrients for this complicated, costly process does not commend itself to commercial practicality. The present invention utilizes the free pollutants from mine acid drainage to provide the ideal conditions for algae growth, therefore, there is no need to add nutrients and gases to provide for maximum growth.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A method of cleaning water to grow algae comprising:
measuring a flow rate of water coming out of AMD discharge to determine the size of holding are needed to grow algae;
measuring the levels of elements in the AMD water to determine if any are lacking for optimal algae growth;
adding artificial light if sunlight is inadequate;
adding heat to the water if required;
adding algae to the water;
removing oxygen gasses in closed loop systems caused by algae emissions;
removing matured algae and repeat process if necessary to remove more of the metals and other undesired element; and
introducing treated water back into the environment.

2. A method of producing biodiesel fuel from algae grown on mine acid drainage ponds comprising:
growing algae on a pond or in a commercially available photoreactor tube,
harvesting the algae from the pond,
removing the oil from the algae, and
using the algae oil as feedstock for conventional production of biodesiel fuel using a base catalyzed transesterification reaction in conventional biodiesel reactor.

3. The method of producing algae according to claim 2 wherein specifically growing the algae using mine acid drainage polluted water and utilizing abandoned mine ponds.
